(19) United States
(12) Patent Application Publication
(10) Pub. No.: US 2025/0254579 A1
(43) Pub. Date: Aug. 7, 2025

(54) MEASUREMENT REPORTING BASED ON MEASUREMENT CONFIGURATIONS USING FREQUENCY SPECIFIC PRIORITY INDICATIONS

(71) Applicant: Telefonaktiebolaget LM Ericsson (publ), Stockholm (SE)

(72) Inventors: Pradeepa Ramachandra, Linköping (SE); Mattias Bergström, Sollentuna (SE)

(21) Appl. No.: 18/702,358

(22) PCT Filed: Oct. 12, 2022
(86) PCT No.: PCT/SE2022/050918

§ 371 Date: Apr. 18, 2024

Related U.S. Application Data
(60) Provisional application No. 63/256,849, filed on Oct. 18, 2021.

(51) Int. Cl. H04W 36/00; H04W 24/10

(52) U.S. Cl. CPC H04W 36/0085; H04W 24/10

(57) ABSTRACT

Systems and methods are disclosed for measurements and measurement reporting based on frequency specific priority indications. In one embodiment, a method performed by a User Equipment (UE) comprises receiving, from a network node, a measurement configuration that comprises one or more priority indications for two or more frequencies. The method further comprises performing measurements on the two or more frequencies in accordance with the one or more priority indications for the two or more frequencies and transmitting, to the network node, one or more measurement reports comprising the measurements performed on the two or more frequencies. In this manner, the network can immediately take an action(s) based on the one or more measurement reports sent by the UE, thus improving UE throughput and also removing the need for timers or multiple higher layer messages before taking the action(s).

### RELATED APPLICATIONS

This application claims the benefit of provisional patent application Ser. No. 63/256,849, filed Oct. 18, 2021, the disclosure of which is hereby incorporated herein by reference in its entirety.

### TECHNICAL FIELD

The present disclosure relates to a cellular communications system and, more specifically, to measurement configuration in a cellular communications system.

### BACKGROUND

Handover is an important part of any mobile communications system. In state-of-the art cellular communications systems, handover is the process of transferring an ongoing connection of a User Equipment (UE) from one base station (i.e., the serving base station) to another base station (i.e., the target base station), or from one cell to another cell within the same base station. This is done to provide connectivity over a larger area than a single cell. The handover should happen without any loss of data and preferably with no interruption.

In Third Generation Partnership Project (3GPP) New Radio (NR), mobility in Radio Resource Control (RCC) connected state (i.e., RRC_CONNECTED) is provided via UE assisted network (NW) controlled handover (HO), with HO preparation signaling.

One important aspect of the mobility procedure in NR is the so-called RRC-based measurement reports. During the RRC connection setup, the network can configure the UE with so-called mobility events with some conditions related to the quality of the serving cell and/or the neighbor cells that when fulfilled triggers the UE to send an RRC MEASUREMENT REPORT. The source NR base station (gNB) can use the MEASUREMENT REPORT and Radio Resource Management (RRM) information for handover decision for the UE. After HO decision is done, the source Gnb prepares the target Gnb for handover and passes relevant information in the handover command to the UE.

Measurement reports are triggered based on pre-configured mobility events defined by certain triggering conditions (e.g., based on filtered measurements). If the conditions of a given mobility event are fulfilled for one or more applicable cells for a Time-To-Trigger (TTT) time duration, the UE initiates the measurement reporting procedure.

The mobility events currently defined in the NR specification are the following:
Event A1: Serving becomes better than threshold
Event A2: Serving becomes worse than threshold
Event A3: Neighbor becomes offset better than Special Cell (SpCell)
Event A4: Neighbor becomes better than threshold
Event A5: SpCell becomes worse than threshold1 and neighbor becomes better than threshold2
Event A6: Neighbor becomes offset better than Secondary Cell (Scell)
Event B1: Inter-Radio Access Technology (RAT) neighbor becomes better than threshold
Event B2: Primary Cell (Pcell) becomes worse than threshold1 and inter RAT neighbor becomes better than threshold2

The UE reports measurement information in accordance with the measurement configuration applicable for a UE in RRC_CONNECTED by means of dedicated signaling. The measurement configuration includes several parameters grouped in information elements (Ies) such as measurement objects, reporting configurations, measurement identities, quantity configurations, and measurement gaps.

The measurement object contains applicable information for Synchronization Signal (SS)/Physical Broadcast Channel (PBCH) block(s) intra/inter-frequency measurements and/or Channel State Information Reference Signal (CSI-RS) intra/inter-frequency measurements. The content of the IE MeasObjectNR is depicted in FIG. 1. In the measurement object, the network may inform the UE to:
only perform measurements on the cells configured using the fields whiteCellsToAddModList and whiteCellsToRemoveList, or
perform measurements on all cells except those configured using the fields blackCellsToAddModList and blackCellsToRemoveList.

The network may also choose not to configure such lists. In that case, which is the most common case, the UE performs measurements on all cells the UE detects on the configured Synchronization Signal Block (SSB) frequency. In general, it is difficult to know beforehand what cells are suitable handover candidates. So, the most common way is to let the UE find the neighbor cells without guidance from the network.

The measurement report transmitted by the UE contains measurements about the cell that triggered the event. The report may also contain measurements on other cells, and also on individual beams of the cell(s).

### SUMMARY

Systems and methods are disclosed for measurements and measurement reporting based on frequency specific priority indications. In one embodiment, a method performed by a User Equipment (UE) comprises receiving, from a network node, a measurement configuration that comprises one or more priority indications for two or more frequencies. The method further comprises performing measurements on the two or more frequencies in accordance with the one or more priority indications for the two or more frequencies and transmitting, to the network node, one or more measurement reports comprising the measurements performed on the two or more frequencies. In this manner, the network can immediately take an action(s) based on the one or more measurement reports sent by the UE, thus improving UE throughput and also removing the need for timers or multiple higher layer messages before taking the action(s).

In one embodiment, performing the measurements on the two or more frequencies in accordance with the one or more priority indications for the two or more frequencies comprises performing the measurements on the two or more frequencies in a chronological order that is defined by the one or more priority indications for the two or more frequencies.

In one embodiment, the UE is in connected mode.

In one embodiment, the method further comprises transmitting, to the network node, a capability indication that indicates an ability of the UE to perform measurements in a configurable chronological order that is defined based on priorities of associated frequencies.

In one embodiment, the one or more priority indications comprise a separate priority indication for each of the two or more frequencies.

Corresponding embodiments of a UE are also disclosed. In one embodiment, a UE is adapted to receive, from a network node, a measurement configuration that comprises one or more priority indications for two or more frequencies. The UE is further adapted to perform measurements on the two or more frequencies in accordance with the one or more priority indications for the two or more frequencies and transmit, to the network node, one or more measurement reports comprising the measurements performed on the two or more frequencies.

In one embodiment, a UE comprises a communication interface comprising a transmitter and a receiver, and processing circuitry associated with the communication interface. The processing circuitry is configured to cause the UE to receive, from a network node, a measurement configuration that comprises one or more priority indications for two or more frequencies, perform measurements on the two or more frequencies in accordance with the one or more priority indications for the two or more frequencies, and transmit, to the network node, one or more measurement reports comprising the measurements performed on the two or more frequencies.

Embodiments of a method performed by a network node are also disclosed. In one embodiment, a method performed by a network node comprises transmitting, to a UE, a measurement configuration that comprises one or more priority indications for two or more frequencies and receiving, from the UE, one or more measurement reports comprising measurements performed on the two or more frequencies in accordance with the measurement configuration.

In one embodiment, the method further comprises performing one or more actions based on the received measurement report(s).

In one embodiment, performing the one or more actions comprises transmitting a handover command to the UE, initiating a secondary cell setup procedure for the UE, or initiating a dual connectivity setup procedure for the UE.

In one embodiment, the UE is in connected mode.

In one embodiment, the method further comprises receiving, from the UE, a capability indication that indicates an ability of the UE to perform measurements in a configurable chronological order that is defined based on priorities of associated frequencies.

Corresponding embodiments of a network node are also disclosed. In one embodiment, a network node is adapted to transmit, to a UE, a measurement configuration that comprises one or more priority indications for two or more frequencies and receive, from the UE, one or more measurement reports comprising measurements performed on the two or more frequencies in accordance with the measurement configuration.

In one embodiment, a network node comprises processing circuitry configured to cause the network node to transmit, to a UE, a measurement configuration that comprises one or more priority indications for two or more frequencies and receive, from the UE, one or more measurement reports comprising measurements performed on the two or more frequencies in accordance with the measurement configuration.

In another embodiment, a method performed by a network node comprises obtaining capability information for a plurality of UEs, wherein the capability information indicates, for each UE, whether the UE has an ability to perform measurements on different frequencies in a configurable chronological order that is defined based on priorities assigned to the different frequencies. The method further comprises transmitting measurement configurations to at least some of the plurality of UEs, the measurement configurations either including one or more priority indications for two or more frequencies or not, based on the capability information for the respective UEs.

In one embodiment, obtaining the capability information for the plurality of UEs comprises obtaining capability information for UEs in a first set of UEs that indicates that the UEs in the first set of UEs each has an ability to perform measurements on different frequencies in a configurable chronological order that is defined based on priorities assigned to the different frequencies and obtaining capability information for UEs in a second set of UEs that indicates that the UEs in the second set of UEs each does not have an ability to perform measurements on different frequencies in a configurable chronological order that is defined based on priorities assigned to the different frequencies. In one embodiment, transmitting the measurement configurations comprises transmitting a first measurement configuration to a first UE in the first set of UEs, the first measurement configuration comprising one or more priority indications for two or more frequencies and transmitting a second measurement configuration to a second UE in the second set of UEs, the second measurement configuration not comprising one or more priority indications for different frequencies. In one embodiment, the method further comprises receiving a first measurement report from the first UE in the first set of UEs and receiving a second measurement report from the second UE in the second set of UEs. In one embodiment, the method further comprises performing one or more actions based on the first measurement report and the second measurement report. In one embodiment, performing one or more actions based on the first measurement report and the second measurement report comprises performing a first set of actions based on the first measurement report as a result of the first UE being in the first set of UEs and performing a second set of actions, which is different than the first set of actions, based on the second measurement report as a result of the second UE being in the second set of UEs. In one embodiment, performing one or more actions based on the first measurement report and the second measurement report comprises determining that the first measurement report is from the first UE in the first set of UEs and, responsive to determining that the first measurement report is from the first UE in the first set of UEs, transmitting a handover command to the first UE, initiating a secondary cell setup procedure for the first UE, or initiating a dual connectivity setup procedure for the first UE. In one embodiment, performing one or more actions based on the first measurement report and the second measurement report comprises determining that the second measurement report is from the second UE in the second set of UEs, determining that measurement(s) in the second measurement report are for a frequency(s) or cell(s) having a priority that is less than a threshold priority, and, responsive to determining that measurement(s) in the second measurement report are for a frequency(s) or cell(s) having a priority that is less than a threshold priority, waiting for a third measurement report from the second UE. In one embodiment, the method further comprises receiving a third measurement report from the second UE and performing an action(s) based on the third measurement report.

In one embodiment, performing one or more actions based on the first measurement report and the second measurement report comprises determining that the second measurement report is from the second UE in the second set of UEs, determining that measurement(s) in the second measurement report are for a frequency(s) or cell(s) having a priority that is greater than a threshold priority, and, responsive to determining that measurement(s) in the second measurement report are for a frequency(s) or cell(s) having a priority that is greater than a threshold priority, transmitting a handover command to the second UE, initiating a secondary cell setup procedure for the second UE, or initiating a dual connectivity setup procedure for the second UE.

Corresponding embodiments of a network node are also disclosed. In one embodiment, a network node is adapted to obtain capability information for a plurality of UEs, wherein the capability information indicates, for each UE, whether the UE has an ability to perform measurements on different frequencies in a configurable chronological order that is defined based on priorities assigned to the different frequencies. The network node is further adapted to transmit measurement configurations to at least some of the plurality of UEs, the measurement configurations either including one or more priority indications for two or more frequencies or not, based on the capability information for the respective UEs.

In another embodiment, a network node comprises processing circuitry configured to cause the network node to obtain capability information for a plurality of UEs, wherein the capability information indicates, for each UE, whether the UE has an ability to perform measurements on different frequencies in a configurable chronological order that is defined based on priorities assigned to the different frequencies. The processing circuitry is further configured to cause the network node to transmit measurement configurations to at least some of the plurality of UEs, the measurement configurations either including one or more priority indications for two or more frequencies or not, based on the capability information for the respective UEs.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates the content of the Information Element (IE) MeasObjectNR as defined in 3^{rd} Generation Partnership Project (3GPP) New Radio (NR) specifications;

FIG. 2 illustrates an example network deployment wherein an operator has up to ‘N’ different frequency layers;

FIG. 3 is a flow chart that illustrates a process performed by a User Equipment (UE) to enable efficient inter-frequency load balancing or dual connectivity setup or multi-connectivity setup or carrier aggregation setup, in accordance with one embodiment of the present disclosure;

FIG. 4 is a flow chart that illustrates a process performed by a network node to enable efficient inter-frequency load balancing or dual connectivity setup or multi-connectivity setup or carrier aggregation setup, in accordance with one embodiment of the present disclosure;

FIGS. 5A and 5B illustrate a flow chart that illustrates a method performed by a first network node to enable efficient inter-frequency load balancing or carrier aggregation setup or dual connectivity setup or multi-connectivity setup in accordance with one embodiment of the present disclosure;

FIG. 6 shows an example of a communication system in accordance with some embodiments;

FIG. 7 shows a UE in accordance with some embodiments;

FIG. 8 shows a network node in accordance with some embodiments;

FIG. 9 is a block diagram of a host, which may be an embodiment of the host of FIG. 6, in accordance with various aspects described herein;

FIG. 10 is a block diagram illustrating a virtualization environment in which functions implemented by some embodiments may be virtualized;

FIG. 11 shows a communication diagram of a host communicating via a network node with a UE over a partially wireless connection in accordance with some embodiments; and

FIGS. 12A through 12H show an example implementation of a solution described herein, e.g., with respect to FIGS. 3 and 4.

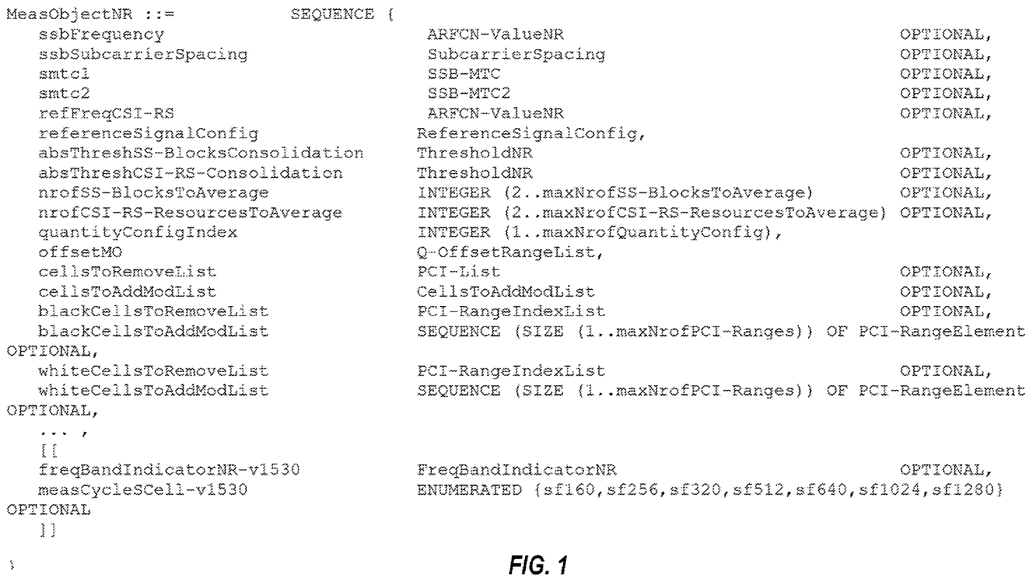

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

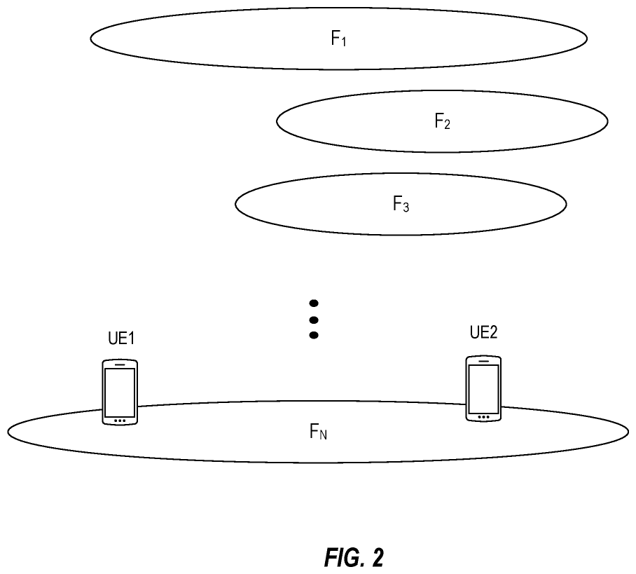

There currently exist certain challenge(s). Having a greater number of frequencies is good in terms of achieving better throughput but it also imposes new challenges on the network side in finding the most suitable frequencies for serving the User Equipment (UE). Consider the example deployment given in FIG. 2. The scenario illustrated in FIG. 2 depicts a network deployment wherein an operator has up to ‘N’ different frequency layers in which the operator has deployed either Long Term Evolution (LTE) or NR radio access technology. There are two UEs (referenced as UE1 and UE2) shown in FIG. 2, and both of these UEs are currently served by F_{N}. Ideally, the network wants to perform load distribution across different frequencies to achieve better performance in terms of throughput, latency, etc. The network configures both UE1 and UE2 to perform measurements on F₁, F₂, F₃, . . . , F_{N-1} and waits for the UE to send measurement reports before making the load sharing/balancing decisions. However, as there is no control over the order in which the UEs performs measurements on F₁, F₂, F₃, . . . , F_{N-1} frequencies, the UEs might perform the measurements on these frequencies in the following order, F₁→F₂→F₃→ . . . →F_{N-1}. This would possibly result in the following results.
1) UE1
   a. Sends a measurement report that a particular cell on F₁ is good
   b. Network initiates a handover procedure or a dual connectivity (DC) setup procedure with the reported cell on F₁
   c. UE1 gets handed over to the cell on F₁ or the DC is setup with the cell on F₁.
2) UE2
   a. Sends a measurement report that a particular cell on F₁ is good
   b. Network initiates a handover procedure or a DC setup procedure with the reported cell on F₁
   c. UE2 gets handed over to the cell on F₁ or the DC is setup with the cell on F₁.
      i. However, UE2 had discovered strong cells on F₂ and F₃ as well but found them after sending the measurement report and just before receiving the handover command or the DC being setup. The resulting decisions would have been much better compared to the decisions taken based on F₁ related measurement report.

Thus, the chronological order in which the UE performs the measurements on different frequencies affects network decisions such as handover decisions and dual connectivity/carrier aggregation configuration.

There are network implementations that can help to improve the decision-making process, but they have some limitations. The following options try to capture such possibilities and list their limitations.
1) Network configures measurements on multiple frequencies but waits a long time before making a decision based on the resulting measurement report(s).
   a. In such a solution, the network waits for multiple measurement reports. Once it has waited a long enough time, it initiates decisions like selecting the target cells for handover and/or selecting the candidates for dual connectivity or carrier aggregation.
   b. For example:
      i. The network configures the UEs with measurements on F₁, F₂, F₃, . . . F_{N-1}.
      ii. The network waits for the UEs to send measurement reports of at least F₁, F₂ and F₃ before it takes the first decision.
      iii. This would result in both UE1 and UE2 being handed over to the best candidates i.e., UE1 would be handed over to a cell in F₁ and the UE2 would be handed over to a cell in F₂/F₃.
   c. The limitation of such a solution is that the UE experiences delay before its performance improves as the network waits before making the decision of handover or DC/CA candidate selection.
2) Network configures measurements on one frequency at a time and configures the measurements on other frequencies based on the outcome of the first frequency results.
   a. In such a solution, the network starts by configuring the UEs with measurements on frequency/frequencies that the network believes to be good candidate for a handover (load balancing related) and/or for DC/CA configuration. The network waits for measurement reports from the UEs before reconfiguring the UEs with measurements on another frequency or taking the handover/DC/CA configuration decisions.
   b. For example:
      i. The network configures both UE1 and UE2 with measurements on F₂ to start with.
      ii. UE2 comes back with a measurement report indicating that it strongly hears a cell on F₂. However, UE1 cannot find any cells on F₂.
      iii. The network configures handover/DC/CA to UE2 towards a cell in F₂. The network configures the UE1 with measurements on F₃.
      iv. UE1 cannot find any cells on F₃.
      v. The network configures the UE1 with measurements on F₁.
      vi. UE1 comes back with a measurement report indicating that it strongly hears a cell on F₁
      vii. The network configures handover/DC/CA to UE2 towards a cell in F₁.
   c. The number of Radio Resource Control (RRC) messages sent over the air (RRCReconfiguration message and measurementReport message) increases significantly.
   d. The delay in finding the best frequencies for the UE increases due to the over-the-air transmission of RRC messages before the next measurement configuration is received.

One method to handle this would be based on introducing priorities for performing the measurements on different frequencies when the UE is in connected mode. Based on such a solution, a UE could be configured with priorities, and the UE performs measurements on the frequencies as per the configured priorities. For example, UE1 and UE2 can be configured with frequency priorities as follows:
1) F₂ is highest priority
2) F₃ is second highest priority
3) F₁ is third highest priority

This configuration can be sent to the UE as part of the measConfig, and both the UEs then start performing the measurements on F₂ initially and then on F₃ and then on F₁. In such a setup, the first measurement report sent by the UE2 would correspond to F₂, and the first measurement report sent by the UE1 would correspond to F₁. Even with such a solution, the network has to account for legacy UEs and the new UEs. A load balancing algorithm running at the network side cannot know at the time of receiving the measurement report as to whether this measurement report is something that can be used to take an immediate action or should it wait for further measurement reports.

Certain aspects of the disclosure and their embodiments may provide solutions to these or other challenges. The present disclosure describes two solutions, denoted herein as “Solution 1” and “Solution 2”. Solution 1 provides systems and methods by which the network can control the chronological order in which the UE performs measurements on neighbor frequencies. Solution 2 provides systems and methods by which the network node can differently take action to a legacy UE and a UE that supports the chronological order of performing measurements on neighbor frequencies. Further details regarding these two solutions are provided in the sections below. Note, however, that these solutions may be used in combination with one another.

Certain embodiments may provide one or more of the following technical advantage(s). In regard to Solution 1, by using embodiments disclosed herein for Solution 1, the network can immediately take actions based on the measurement report sent by the UE, thus improving the UE throughput and also removing the need for timers or multiple RRC messages before taking the action. In regard to Solution 2, by using the methods proposed for Solution 2, the network can differentiate the decision making for legacy UEs and for those UEs that support the configuration of chronological order of performing neighbor frequencies' related measurements thus enabling better and faster load sharing feature or dual connectivity set up.

### 1 Solution 1

### 1.1 UE Side Aspects

In one embodiment of Solution 1, a method performed by a UE comprises receiving priorities for performing measurements on different frequencies when the UE is in connected mode. The method further comprises performing the measurements on the frequencies in a chronological order as per the configured priorities.

For example, two UEs (referred to herein as UE1 and UE2) can be configured with frequency priorities as follows:
1) F₂ is highest priority
2) F₃ is second highest priority
3) F₁ is third highest priority

This configuration can be sent to each of the UEs as part of a measurement configuration (e.g., a part of the measConfig), and both of the UEs then start performing the measurements on F₂ initially and then on F₃ and then on F₁. In such a setup, considering the example described above with respect to FIG. 2, the first measurement report sent by UE2 would correspond to F₂, and the first measurement report sent by the UE1 would correspond to F₁.

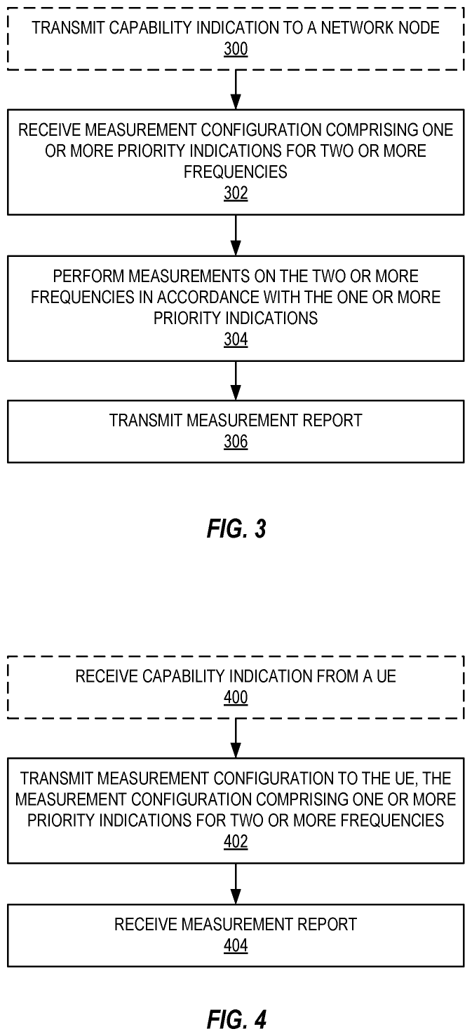

In this regard, FIG. 3 is a flow chart that illustrates a process performed by a UE to enable efficient inter-frequency load balancing or dual connectivity setup or multi-connectivity setup or carrier aggregation setup, in accordance with one embodiment of the present disclosure. As illustrated, the process of FIG. 3 includes the following:
Step 300 (optional): The UE transmits a capability indication to a network node, wherein the capability indication indicates the ability of the UE to perform measurements on frequencies in a configurable chronological order. The network node may be a Radio Access Network (RAN) node such as, e.g., a base station (e.g., a gNB) or a RAN node that provides at least part of the functionality of a base station (e.g., a gNB Distributed Unit (gNB-DU) or gNB Central Unit (gNB-CU)).
Step 302: The UE receives a measurement configuration from a network node, wherein the measurement configuration comprises one or more priority indications for two or more frequencies. In one embodiment, a separate priority indication is provided for each of the two or more frequencies. In another embodiment, a priority indication is provided for at least one of the two or more frequencies and, e.g., the rest of the two or more frequencies may implicitly be assigned a predefined or preconfigured default priority.
Step 304: The UE performs measurements on the two or more frequencies according to the configured one or more priority indications.
Step 306: The UE transmits a measurement report to the network node, the measurement report comprising the performed measurements

In one embodiment, the one or more priority indications indicates the chronological order for performing the measurements on different frequencies.

### 1.2 Network Side Aspects

In one embodiment, a method performed by a network node includes the following. The network node configures a UE with a list of priorities wherein the list of priorities indicate the chronological order in which the UE is to perform inter-frequency measurements. In one embodiment, the method performed by the network node further comprises receiving a measurement report(s) from the UE based on the configuration. The network node may be a RAN node such as, e.g., a base station (e.g., a gNB) or a RAN node that provides at least part of the functionality of a base station (e.g., a gNB-DU or gNB-CU).

In this regard, FIG. 4 is a flow chart that illustrates a process performed by a network node to enable efficient inter-frequency load balancing or dual connectivity setup or multi-connectivity setup or carrier aggregation setup, in accordance with one embodiment of the present disclosure. As illustrated, the method includes the following steps:
Step 400 (optional): The network node receives a capability indication from a UE indicating an ability of the UE to perform the measurements on frequencies in a configurable chronological order.
Step 402: The network node transmits a measurement configuration to the UE, the measurement configuration comprising one or more priority indications for two or more frequencies.
Step 404: The network node receives a measurement report from the UE, the measurement report comprising measurement(s) on two or more of the configured frequencies.

The network may then perform one or more actions (e.g., transmitting a handover command to the UE, initiating a secondary cell setup procedure for the UE, or initiating a dual connectivity setup procedure for the UE) based on the received measurement report(s), as will be appreciated by those of ordinary skill in the art upon reading this disclosure.

### 1.3 Example Implementation of Solution 1

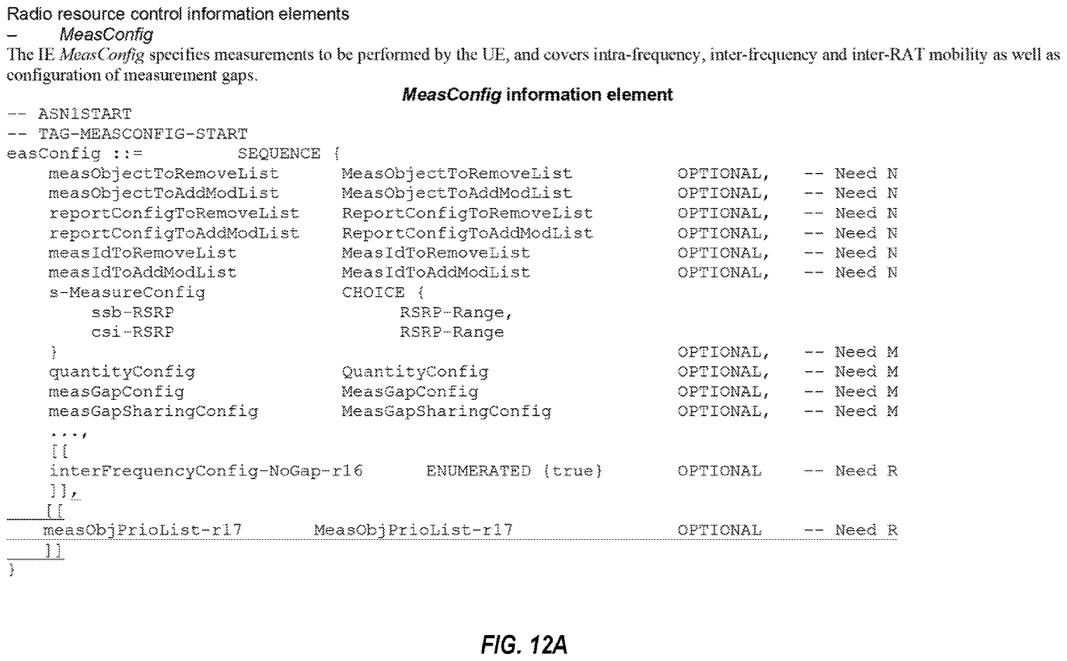

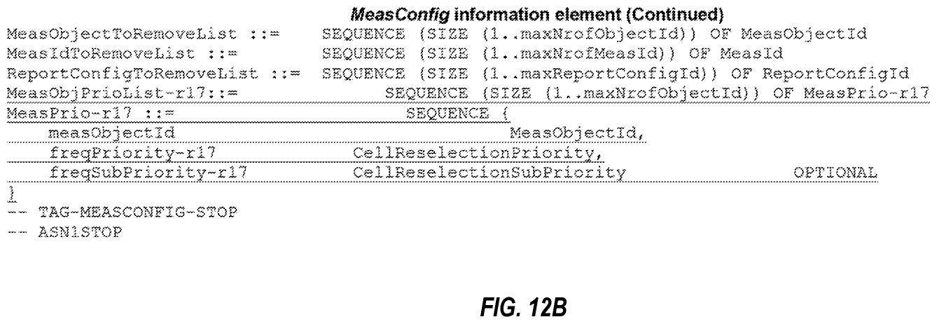

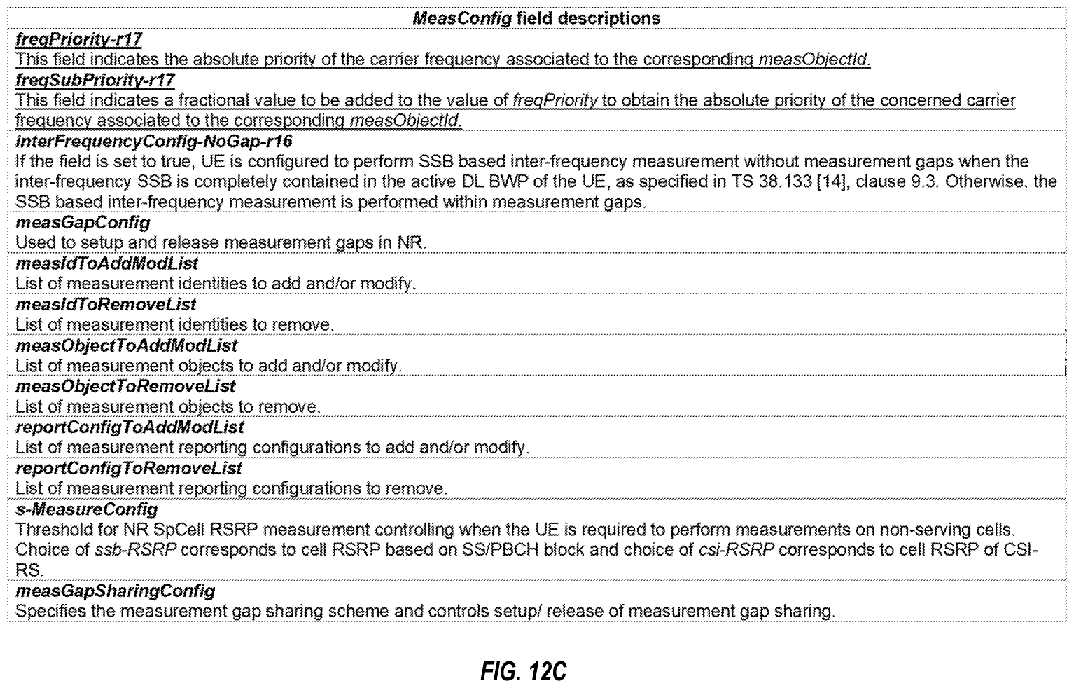

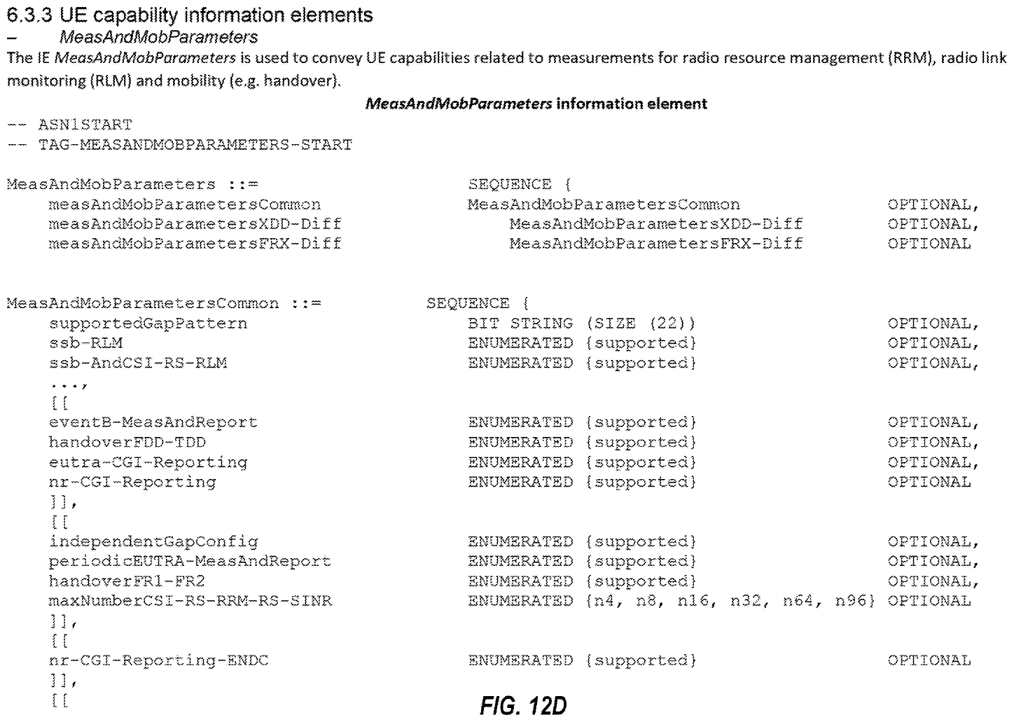

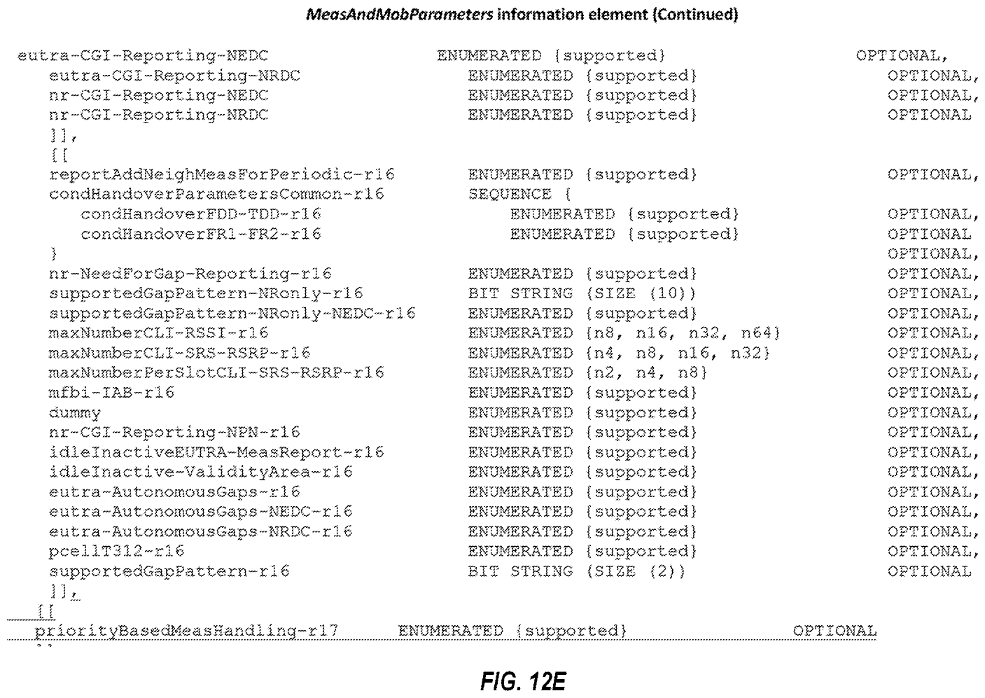

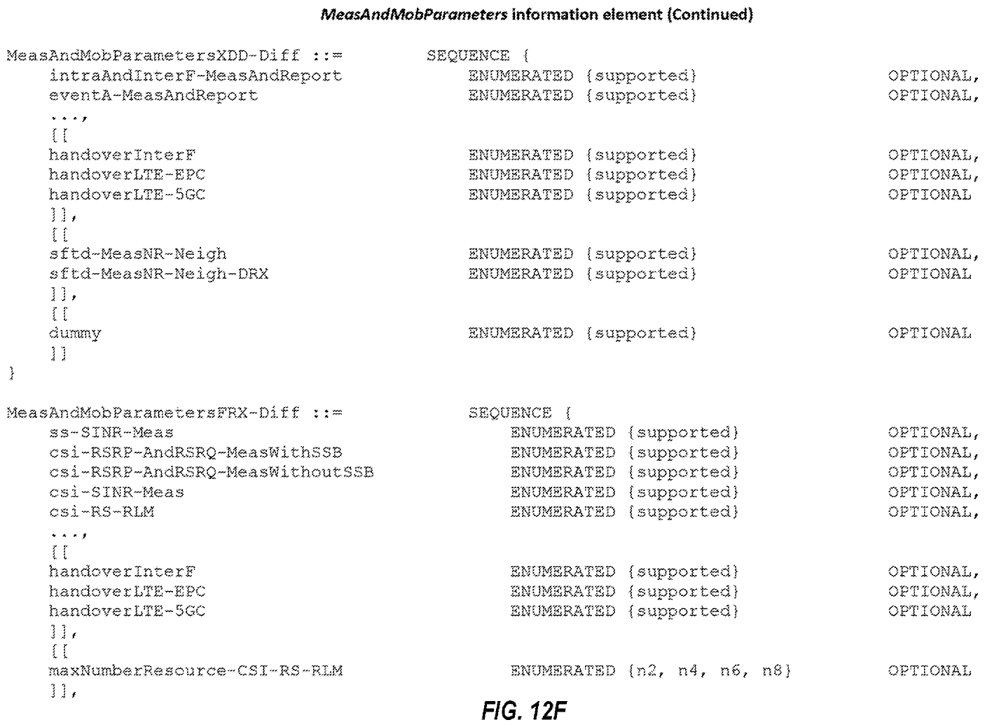

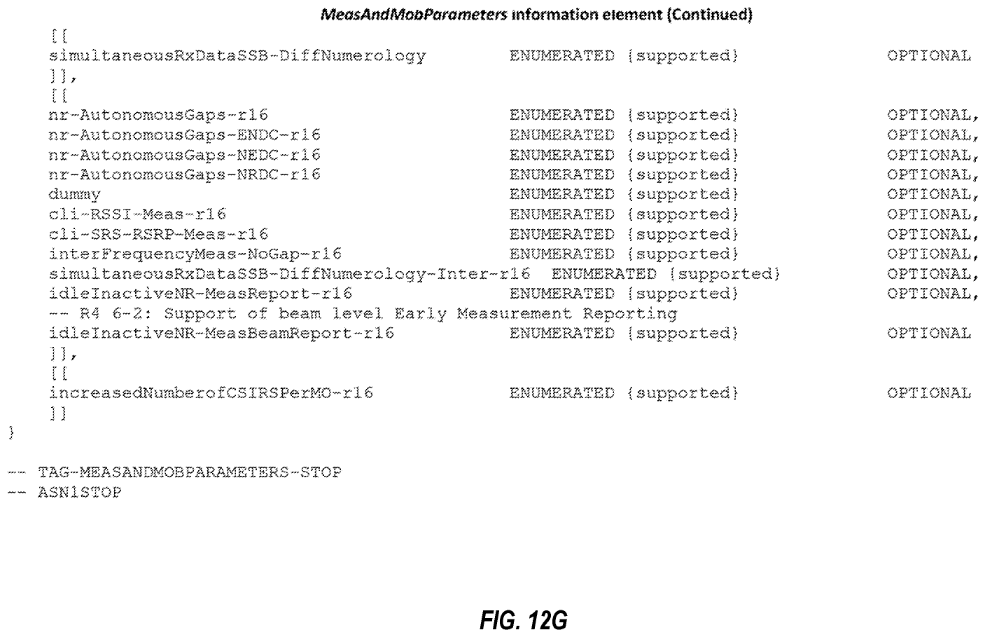

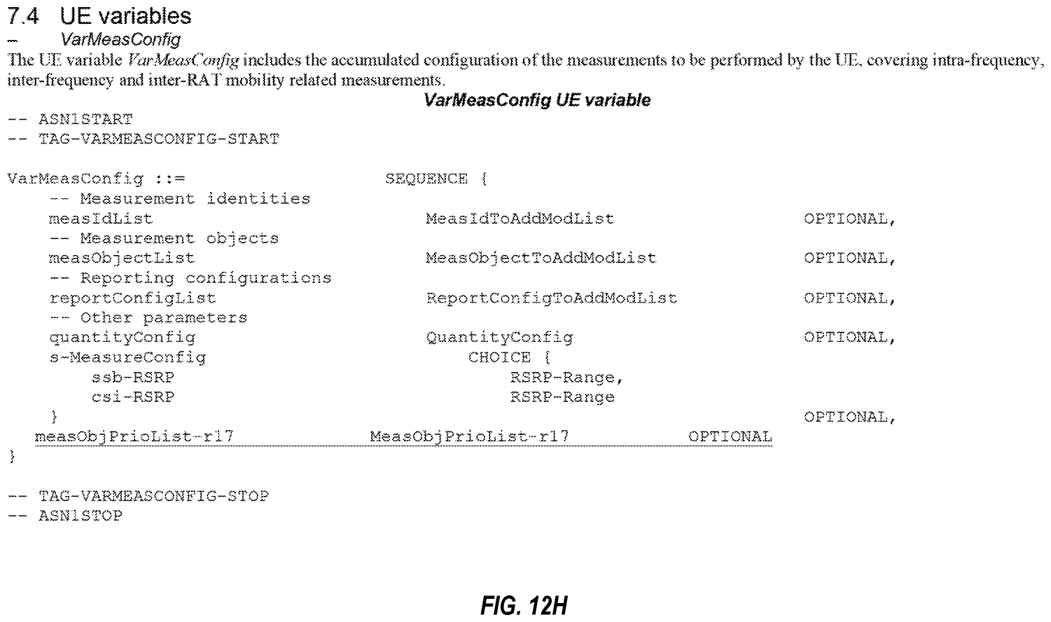

An example implementation of Solution 1 is given below. The existing RRC specification version 16.6.0 has been used as baseline and the changes to implement solution 1 is shown with underlined text in FIG. 12A through FIG. 12H.

### 2 Solution 2

### 2.1 Network Side Aspects

In one embodiment, a method performed by a network node comprises performing, by the network node, different actions for different UEs depending on their capability to perform measurements on different frequencies in a chronological order.

For a UE that is not capable of performing measurement on different frequencies in a chronological order as per network-configured priorities (e.g., as described above with respect to Solution 1), upon receiving a measurement report on an inter-frequency measurement, the network node waits for further measurement reports or for a fixed duration of time before taking an action. The action may be a mobility event such as transmitting a handover request or initiating setup of carrier aggregation or dual connectivity setup. Setting up dual connectivity may comprise requesting a neighbor network node to setup dual connectivity.

For a UE that is capable of performing measurement on different frequencies in a chronological order as per network-configured priorities (e.g., as described above with respect to Solution 1), upon receiving a measurement report on an inter-frequency measurement, the network node transmits a handover request or dual connectivity setup request to a neighbor network node without waiting for further measurement reports from the UE for a fixed duration.

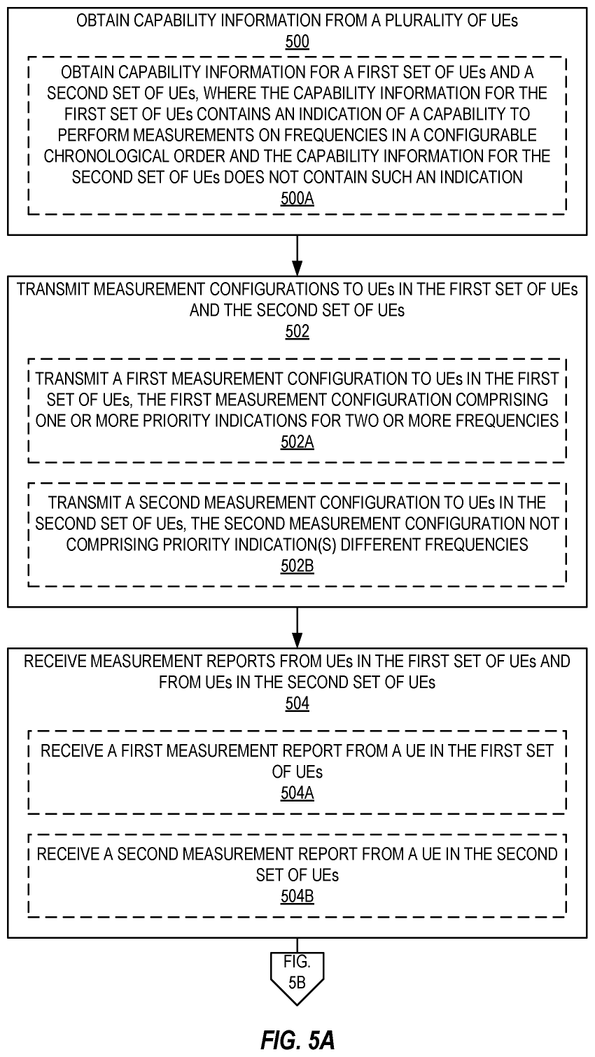

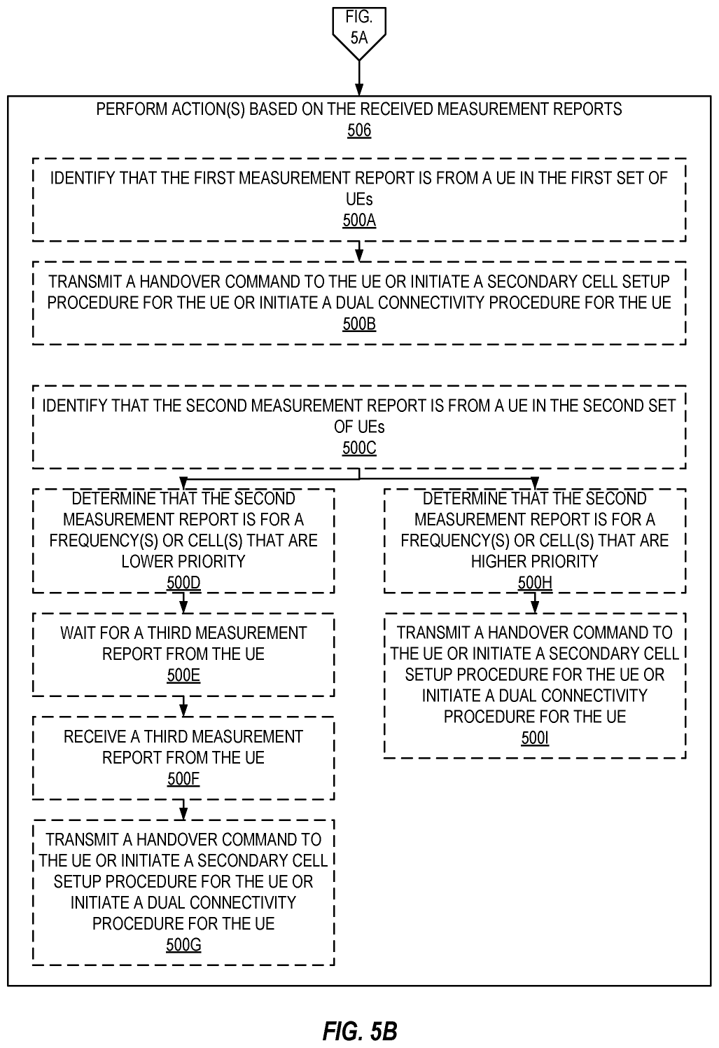

FIGS. 5A and 5B illustrate a flow chart that illustrates a method performed by a first network node to enable efficient inter-frequency load balancing or carrier aggregation setup or dual connectivity setup or multi-connectivity setup in accordance with one embodiment of the present disclosure. Optional steps are represented by dashed lines/boxes. As illustrated, the method performed by the first network node comprises:
Step 500: The first network node obtains capability information for a plurality of UEs. More specifically, in one embodiment:
   Step 500A: The first network node obtains capability information for a first set of UEs and obtains capability information for a second set of UEs. The capability information for the first set of UEs contains an indication indicating the ability to perform the measurements on frequencies in a configurable chronological order. The capability information for the second set of UEs is missing (i.e., does not include) an indication indicating the ability to perform the measurements on frequencies in a configurable chronological order.
Step 502: The first network node transmits measurement configurations to UEs in the first set of UEs and to UEs in the second set of UEs, e.g., in accordance with their capabilities obtained in step 4300. In one embodiment:
   Step 502A: The first network node transmits a first measurement configuration to a first set of UEs. The first measurement configuration contains one or more priority indications indicating the chronological order for performing the measurements on different frequencies configured in the first measurement configuration.
   Step 502B: The first network node transmits a second measurement configuration to a second set of UEs. The second measurement configuration is missing (i.e., does not include) priority indications indicating the chronological order for performing the measurements on different frequencies configured in the second measurement configuration.
   The chronological order of performing measurements may be set by the network such that the UE shall measure certain high priority frequencies or cells first, and after that measure frequencies or cells of lower priority.
Step 504: The first network node receives measurement reports from UEs in the first set of UEs and from UEs in the second set of UEs. In one embodiment,:
   Step 504A: The first network node receives a first measurement report from a UE of the first set of UEs, the measurement report containing measurements on one or more cells.
   Step 504B: The first network node receives a second measurement report from a UE of the second set of UEs, the measurement report containing measurements of one or more cells.
Step 506: The first network node performs one or more actions based on the measurement reports received in step 504. In one embodiment:
   Step 506A: The first network node identifies that the first measurement report comes from a UE belonging to the first set of UEs and upon doing so:
      Step 506B: The first network node transmits a handover command to the UE or initiates a secondary cell setup procedure for the UE or initiates a dual connectivity setup procedure for the UE.
   Step 506C: The first network node identifies that the second measurement report comes from a UE belonging to the second set of UEs and upon doing so:
      Step 506D: The first network node determines that the measurements in the second measurement report are for a frequencies or cells which the first network node considers are of lower priority and in response to this:
         Step 506E: The first network node waits to receive a third measurement report from the UE. This waiting may only be for a limited amount of time (e.g., a predefined or preconfigured amount of time).
         Step 506F: The first network node receives a third measurement report from the UE, the third measurement report containing measurements of one or more cells on a frequency which the first network node considers are of higher priority.
         Step 506G: In response to receiving the third measurement report or in response to having waited a certain period of time, the first network node transmits a handover command to the UE or initiates a secondary cell setup procedure for the UE or initiates a dual connectivity setup procedure for the UE.
      Step 506H: The first network node determines that the measurements in the second measurement report are for a frequencies or cells which the network node considers are of higher priority and in response to this:
         Step 506I: The first network node transmits a handover command to the UE or initiates a secondary cell setup procedure for the UE or initiates a dual connectivity setup procedure for the UE.

The benefit of the above is that the network can act directly on the first measurement report from the first UE since the network knows that, when the UE sends the report, the UE has already measured on frequencies or cells which the network considers high priority. However, for the second measurement report from the second UE, the network does not automatically know that the UE has already measured on the frequencies that the network considers high priority; hence, the network waits (a certain period of time) in case the UE will (e.g., soon) send a third measurement report comprising measurements of high priority frequencies or cells.

### 3 Further Details

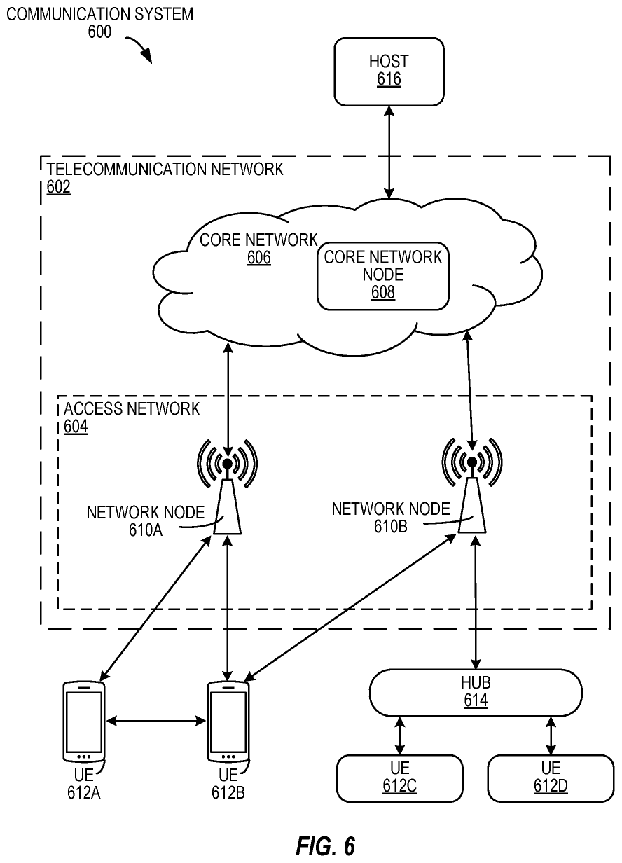

FIG. 6 shows an example of a communication system 600 in accordance with some embodiments.

In the example, the communication system 600 includes a telecommunication network 602 that includes an access network 604, such as a Radio Access Network (RAN), and a core network 606, which includes one or more core network nodes 608. The access network 604 includes one or more access network nodes, such as network nodes 610A and 610B (one or more of which may be generally referred to as network nodes 610), or any other similar Third Generation Partnership Project (3GPP) access node or non-3GPP Access Point (AP). The network nodes 610 facilitate direct or indirect connection of User Equipment (UE), such as by connecting UEs 612A, 612B, 612C, and 612D (one or more of which may be generally referred to as UEs 612) to the core network 606 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 600 may include any number of wired or wireless networks, network nodes, UEs, and/or any other components or systems that may facilitate or participate in the communication of data and/or signals whether via wired or wireless connections. The communication system 600 may include and/or interface with any type of communication, telecommunication, data, cellular, radio network, and/or other similar type of system.

The UEs 612 may be any of a wide variety of communication devices, including wireless devices arranged, configured, and/or operable to communicate wirelessly with the network nodes 610 and other communication devices. Similarly, the network nodes 610 are arranged, capable, configured, and/or operable to communicate directly or indirectly with the UEs 612 and/or with other network nodes or equipment in the telecommunication network 602 to enable and/or provide network access, such as wireless network access, and/or to perform other functions, such as administration in the telecommunication network 602.

In the depicted example, the core network 606 connects the network nodes 610 to one or more hosts, such as host 616. These connections may be direct or indirect via one or more intermediary networks or devices. In other examples, network nodes may be directly coupled to hosts. The core network 606 includes one more core network nodes (e.g., core network node 608) that are structured with hardware and software components. Features of these components may be substantially similar to those described with respect to the UEs, network nodes, and/or hosts, such that the descriptions thereof are generally applicable to the corresponding components of the core network node 608. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-Concealing Function (SIDF), Unified Data Management (UDM), Security Edge Protection Proxy (SEPP), Network Exposure Function (NEF), and/or a User Plane Function (UPF).

The host 616 may be under the ownership or control of a service provider other than an operator or provider of the access network 604 and/or the telecommunication network 602, and may be operated by the service provider or on behalf of the service provider. The host 616 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 600 of FIG. 6 enables connectivity between the UEs, network nodes, and hosts. In that sense, the communication system 600 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable Second, Third, Fourth, or Fifth Generation (2G, 3G, 4G, or 5G) standards, or any applicable future generation standard (e.g., Sixth Generation (6G)); Wireless Local Area Network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any Low Power Wide Area Network (LPWAN) standards such as LoRa and Sigfox.

In some examples, the telecommunication network 602 is a cellular network that implements 3GPP standardized features. Accordingly, the telecommunication network 602 may support network slicing to provide different logical networks to different devices that are connected to the telecommunication network 602. For example, the telecommunication network 602 may provide Ultra Reliable Low Latency Communication (URLLC) services to some UEs, while providing enhanced Mobile Broadband (eMBB) services to other UEs, and/or massive Machine Type Communication (mMTC)/massive Internet of Things (IoT) services to yet further UEs.

In some examples, the UEs 612 are configured to transmit and/or receive information without direct human interaction. For instance, a UE may be designed to transmit information to the access network 604 on a predetermined schedule, when triggered by an internal or external event, or in response to requests from the access network 604. Additionally, a UE may be configured for operating in single- or multi-Radio Access Technology (RAT) or multi-standard mode. For example, a UE may operate with any one or combination of WiFi, New Radio (NR), and LTE, i.e. be configured for Multi-Radio Dual Connectivity (MR-DC), such as Evolved UMTS Terrestrial RAN (E-UTRAN) NR-Dual Connectivity (EN-DC).

In the example, a hub 614 communicates with the access network 604 to facilitate indirect communication between one or more UEs (e.g., UE 612C and/or 612D) and network nodes (e.g., network node 610B). In some examples, the hub 614 may be a controller, router, content source and analytics, or any of the other communication devices described herein regarding UEs. For example, the hub 614 may be a broadband router enabling access to the core network 606 for the UEs. As another example, the hub 614 may be a controller that sends commands or instructions to one or more actuators in the UEs. Commands or instructions may be received from the UEs, network nodes 610, or by executable code, script, process, or other instructions in the hub 614. As another example, the hub 614 may be a data collector that acts as temporary storage for UE data and, in some embodiments, may perform analysis or other processing of the data. As another example, the hub 614 may be a content source. For example, for a UE that is a Virtual Reality (VR) headset, display, loudspeaker or other media delivery device, the hub 614 may retrieve VR assets, video, audio, or other media or data related to sensory information via a network node, which the hub 614 then provides to the UE either directly, after performing local processing, and/or after adding additional local content. In still another example, the hub 614 acts as a proxy server or orchestrator for the UEs, in particular in if one or more of the UEs are low energy IoT devices.

The hub 614 may have a constant/persistent or intermittent connection to the network node 610B. The hub 614 may also allow for a different communication scheme and/or schedule between the hub 614 and UEs (e.g., UE 612C and/or 612D), and between the hub 614 and the core network 606. In other examples, the hub 614 is connected to the core network 606 and/or one or more UEs via a wired connection. Moreover, the hub 614 may be configured to connect to a Machine-to-Machine (M2M) service provider over the access network 604 and/or to another UE over a direct connection. In some scenarios, UEs may establish a wireless connection with the network nodes 610 while still connected via the hub 614 via a wired or wireless connection. In some embodiments, the hub 614 may be a dedicated hub—that is, a hub whose primary function is to route communications to/from the UEs from/to the network node 610B. In other embodiments, the hub 614 may be a non-dedicated hub—that is, a device which is capable of operating to route communications between the UEs and the network node 610B, but which is additionally capable of operating as a communication start and/or end point for certain data channels.

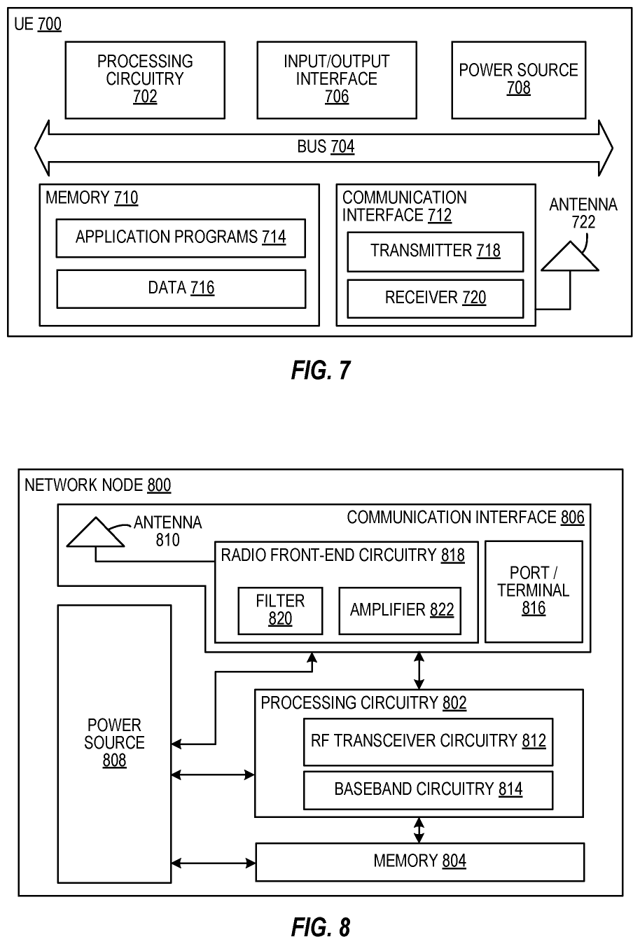

FIG. 7 shows a UE 700 in accordance with some embodiments. As used herein, a UE refers to a device capable, configured, arranged, and/or operable to communicate wirelessly with network nodes and/or other UEs. Examples of a UE include, but are not limited to, a smart phone, mobile phone, cell phone, Voice over Internet Protocol (VOIP) phone, wireless local loop phone, desktop computer, Personal Digital Assistant (PDA), wireless camera, gaming console or device, music storage device, playback appliance, wearable terminal device, wireless endpoint, mobile station, tablet, laptop, Laptop Embedded Equipment (LEE), Laptop Mounted Equipment (LME), smart device, wireless Customer Premise Equipment (CPE), vehicle-mounted or vehicle embedded/integrated wireless device, etc. Other examples include any UE identified by the 3GPP, including a Narrowband Internet of Things (NB-IoT) UE, a Machine Type Communication (MTC) UE, and/or an enhanced MTC (eMTC) UE.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V2I), or Vehicle-to-Everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 700 includes processing circuitry 702 that is operatively coupled via a bus 704 to an input/output interface 706, a power source 708, memory 710, a communication interface 712, and/or any other component, or any combination thereof. Certain UEs may utilize all or a subset of the components shown in FIG. 7. The level of integration between the components may vary from one UE to another UE. Further, certain UEs may contain multiple instances of a component, such as multiple processors, memories, transceivers, transmitters, receivers, etc.

The processing circuitry 702 is configured to process instructions and data and may be configured to implement any sequential state machine operative to execute instructions stored as machine-readable computer programs in the memory 710. The processing circuitry 702 may be implemented as one or more hardware-implemented state machines (e.g., in discrete logic, Field Programmable Gate Arrays (FPGAs), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 702 may include multiple Central Processing Units (CPUs).

In the example, the input/output interface 706 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 700. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 708 is structured as a battery or battery pack. Other types of power sources, such as an external power source (e.g., an electricity outlet), photovoltaic device, or power cell, may be used. The power source 708 may further include power circuitry for delivering power from the power source 708 itself, and/or an external power source, to the various parts of the UE 700 via input circuitry or an interface such as an electrical power cable. Delivering power may be, for example, for charging the power source 708. Power circuitry may perform any formatting, converting, or other modification to the power from the power source 708 to make the power suitable for the respective components of the UE 700 to which power is supplied.

The memory 710 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 710 includes one or more application programs 714, such as an operating system, web browser application, a widget, gadget engine, or other application, and corresponding data 716. The memory 710 may store, for use by the UE 700, any of a variety of various operating systems or combinations of operating systems.

The memory 710 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 710 may allow the UE 700 to access instructions, application programs, and the like stored on transitory or non-transitory memory media, to off-load data, or to upload data. An article of manufacture, such as one utilizing a communication system, may be tangibly embodied as or in the memory 710, which may be or comprise a device-readable storage medium.

The processing circuitry 702 may be configured to communicate with an access network or other network using the communication interface 712. The communication interface 712 may comprise one or more communication subsystems and may include or be communicatively coupled to an antenna 722. The communication interface 712 may include one or more transceivers used to communicate, such as by communicating with one or more remote transceivers of another device capable of wireless communication (e.g., another UE or a network node in an access network). Each transceiver may include a transmitter 718 and/or a receiver 720 appropriate to provide network communications (e.g., optical, electrical, frequency allocations, and so forth). Moreover, the transmitter 718 and receiver 720 may be coupled to one or more antennas (e.g., the antenna 722) and may share circuit components, software, or firmware, or alternatively be implemented separately.

In the illustrated embodiment, communication functions of the communication interface 712 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HTTP), and so forth.

Regardless of the type of sensor, a UE may provide an output of data captured by its sensors, through its communication interface 712, or via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, a television, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or VR, a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 700 shown in FIG. 7.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship, an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

FIG. 8 shows a network node 800 in accordance with some embodiments. As used herein, network node refers to equipment capable, configured, arranged, and/or operable to communicate directly or indirectly with a UE and/or with other network nodes or equipment in a telecommunication network. Examples of network nodes include, but are not limited to, APs (e.g., radio APs), Base Stations (BSs) (e.g., radio BSs, Node Bs, evolved Node Bs (eNBs), and NR Node Bs (gNBs)).

BSs may be categorized based on the amount of coverage they provide (or, stated differently, their transmit power level) and so, depending on the provided amount of coverage, may be referred to as femto BSs, pico BSs, micro BSs, or macro BSs. A BS may be a relay node or a relay donor node controlling a relay. A network node may also include one or more (or all) parts of a distributed radio BS such as centralized digital units and/or Remote Radio Units (RRUs), sometimes referred to as Remote Radio Heads (RRHs). Such RRUs may or may not be integrated with an antenna as an antenna integrated radio. Parts of a distributed radio BS may also be referred to as nodes in a Distributed Antenna System (DAS).

Other examples of network nodes include multiple Transmission Point (multi-TRP) 5G access nodes, Multi-Standard Radio (MSR) equipment such as MSR BSs, network controllers such as Radio Network Controllers (RNCs) or BS Controllers (BSCs), Base Transceiver Stations (BTSs), transmission points, transmission nodes, Multi-Cell/Multicast Coordination Entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 800 includes processing circuitry 802, memory 804, a communication interface 806, and a power source 808. The network node 800 may be composed of multiple physically separate components (e.g., a Node B component and an RNC component, or a BTS component and a BSC component, etc.), which may each have their own respective components. In certain scenarios in which the network node 800 comprises multiple separate components (e.g., BTS and BSC components), one or more of the separate components may be shared among several network nodes. For example, a single RNC may control multiple Node Bs. In such a scenario, each unique Node B and RNC pair may in some instances be considered a single separate network node. In some embodiments, the network node 800 may be configured to support multiple RATs. In such embodiments, some components may be duplicated (e.g., separate memory 804 for different RATs) and some components may be reused (e.g., an antenna 810 may be shared by different RATs). The network node 800 may also include multiple sets of the various illustrated components for different wireless technologies integrated into network node 800, for example GSM, WCDMA, LTE, NR, WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 800.

The processing circuitry 802 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other network node 800 components, such as the memory 804, to provide network node 800 functionality.

In some embodiments, the processing circuitry 802 includes a System on a Chip (SOC). In some embodiments, the processing circuitry 802 includes one or more of Radio Frequency (RF) transceiver circuitry 812 and baseband processing circuitry 814. In some embodiments, the RF transceiver circuitry 812 and the baseband processing circuitry 814 may be on separate chips (or sets of chips), boards, or units, such as radio units and digital units. In alternative embodiments, part or all of the RF transceiver circuitry 812 and the baseband processing circuitry 814 may be on the same chip or set of chips, boards, or units.

The memory 804 may comprise any form of volatile or non-volatile computer-readable memory including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 802. The memory 804 may store any suitable instructions, data, or information, including a computer program, software, an application including one or more of logic, rules, code, tables, and/or other instructions capable of being executed by the processing circuitry 802 and utilized by the network node 800. The memory 804 may be used to store any calculations made by the processing circuitry 802 and/or any data received via the communication interface 806. In some embodiments, the processing circuitry 802 and the memory 804 are integrated.

The communication interface 806 is used in wired or wireless communication of signaling and/or data between a network node, access network, and/or UE. As illustrated, the communication interface 806 comprises port(s)/terminal(s) 816 to send and receive data, for example to and from a network over a wired connection. The communication interface 806 also includes radio front-end circuitry 818 that may be coupled to, or in certain embodiments a part of, the antenna 810. The radio front-end circuitry 818 comprises filters 820 and amplifiers 822. The radio front-end circuitry 818 may be connected to the antenna 810 and the processing circuitry 802. The radio front-end circuitry 818 may be configured to condition signals communicated between the antenna 810 and the processing circuitry 802. The radio front-end circuitry 818 may receive digital data that is to be sent out to other network nodes or UEs via a wireless connection. The radio front-end circuitry 818 may convert the digital data into a radio signal having the appropriate channel and bandwidth parameters using a combination of the filters 820 and/or the amplifiers 822. The radio signal may then be transmitted via the antenna 810. Similarly, when receiving data, the antenna 810 may collect radio signals which are then converted into digital data by the radio front-end circuitry 818. The digital data may be passed to the processing circuitry 802. In other embodiments, the communication interface 806 may comprise different components and/or different combinations of components.

In certain alternative embodiments, the network node 800 does not include separate radio front-end circuitry 818; instead, the processing circuitry 802 includes radio front-end circuitry and is connected to the antenna 810. Similarly, in some embodiments, all or some of the RF transceiver circuitry 812 is part of the communication interface 806. In still other embodiments, the communication interface 806 includes the one or more ports or terminals 816, the radio front-end circuitry 818, and the RF transceiver circuitry 812 as part of a radio unit (not shown), and the communication interface 806 communicates with the baseband processing circuitry 814, which is part of a digital unit (not shown).

The antenna 810 may include one or more antennas, or antenna arrays, configured to send and/or receive wireless signals. The antenna 810 may be coupled to the radio front-end circuitry 818 and may be any type of antenna capable of transmitting and receiving data and/or signals wirelessly. In certain embodiments, the antenna 810 is separate from the network node 800 and connectable to the network node 800 through an interface or port.

The antenna 810, the communication interface 806, and/or the processing circuitry 802 may be configured to perform any receiving operations and/or certain obtaining operations described herein as being performed by the network node 800. Any information, data, and/or signals may be received from a UE, another network node, and/or any other network equipment. Similarly, the antenna 810, the communication interface 806, and/or the processing circuitry 802 may be configured to perform any transmitting operations described herein as being performed by the network node 800. Any information, data, and/or signals may be transmitted to a UE, another network node, and/or any other network equipment.

The power source 808 provides power to the various components of the network node 800 in a form suitable for the respective components (e.g., at a voltage and current level needed for each respective component). The power source 808 may further comprise, or be coupled to, power management circuitry to supply the components of the network node 800 with power for performing the functionality described herein. For example, the network node 800 may be connectable to an external power source (e.g., the power grid or an electricity outlet) via input circuitry or an interface such as an electrical cable, whereby the external power source supplies power to power circuitry of the power source 808. As a further example, the power source 808 may comprise a source of power in the form of a battery or battery pack which is connected to, or integrated in, power circuitry. The battery may provide backup power should the external power source fail.

Embodiments of the network node 800 may include additional components beyond those shown in FIG. 8 for providing certain aspects of the network node's functionality, including any of the functionality described herein and/or any functionality necessary to support the subject matter described herein. For example, the network node 800 may include user interface equipment to allow input of information into the network node 800 and to allow output of information from the network node 800. This may allow a user to perform diagnostic, maintenance, repair, and other administrative functions for the network node 800.

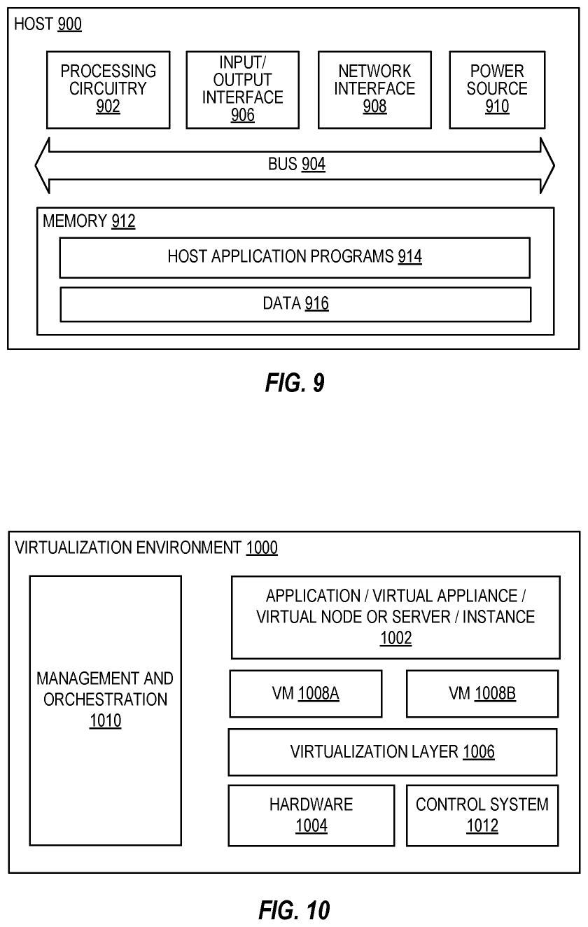

FIG. 9 is a block diagram of a host 900, which may be an embodiment of the host 616 of FIG. 6, in accordance with various aspects described herein. As used herein, the host 900 may be or comprise various combinations of hardware and/or software including a standalone server, a blade server, a cloud-implemented server, a distributed server, a virtual machine, container, or processing resources in a server farm. The host 900 may provide one or more services to one or more UEs.

The host 900 includes processing circuitry 902 that is operatively coupled via a bus 904 to an input/output interface 906, a network interface 908, a power source 910, and memory 912. Other components may be included in other embodiments. Features of these components may be substantially similar to those described with respect to the devices of previous figures, such as FIGS. 7 and 8, such that the descriptions thereof are generally applicable to the corresponding components of the host 900.

The memory 912 may include one or more computer programs including one or more host application programs 914 and data 916, which may include user data, e.g. data generated by a UE for the host 900 or data generated by the host 900 for a UE. Embodiments of the host 900 may utilize only a subset or all of the components shown. The host application programs 914 may be implemented in a container-based architecture and may provide support for video codecs (e.g., Versatile Video Coding (VVC), High Efficiency Video Coding (HEVC), Advanced Video Coding (AVC), Moving Picture Experts Group (MPEG), VP9) and audio codecs (e.g., Free Lossless Audio Codec (FLAC), Advanced Audio Coding (AAC), MPEG, G.711), including transcoding for multiple different classes, types, or implementations of UEs (e.g., handsets, desktop computers, wearable display systems, and heads-up display systems). The host application programs 914 may also provide for user authentication and licensing checks and may periodically report health, routes, and content availability to a central node, such as a device in or on the edge of a core network. Accordingly, the host 900 may select and/or indicate a different host for Over-The-Top (OTT) services for a UE. The host application programs 914 may support various protocols, such as the HTTP Live Streaming (HLS) protocol, Real-Time Messaging Protocol (RTMP), Real-Time Streaming Protocol (RTSP), Dynamic Adaptive Streaming over HTTP (DASH or MPEG-DASH), etc.

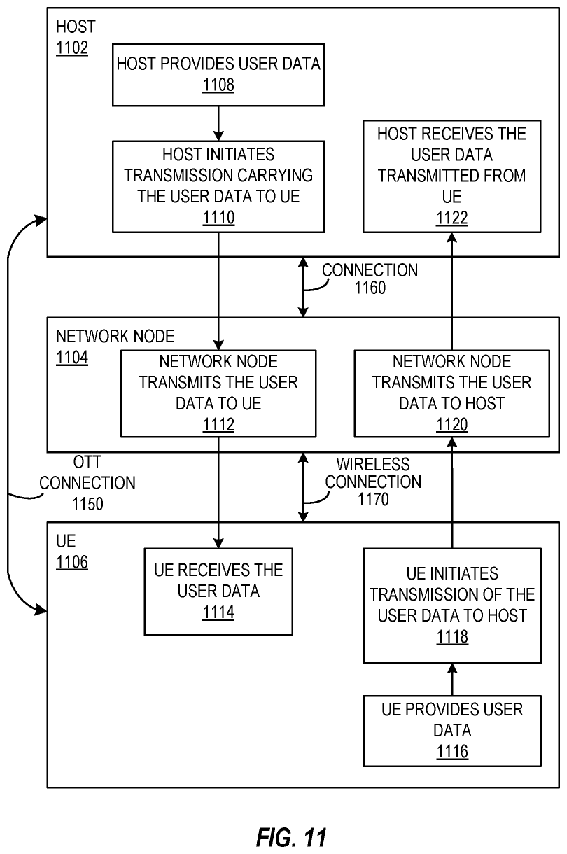

FIG. 10 is a block diagram illustrating a virtualization environment 1000 in which functions implemented by some embodiments may be virtualized. In the present context, virtualizing means creating virtual versions of apparatuses or devices which may include virtualizing hardware platforms, storage devices, and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more Virtual Machines (VMs) implemented in one or more virtual environments 1000 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1002 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1004 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1006 (also referred to as hypervisors or VM Monitors (VMMs)), provide VMs 1008A and 1008B (one or more of which may be generally referred to as VMs 1008), and/or perform any of the functions, features, and/or benefits described in relation with some embodiments described herein. The virtualization layer 1006 may present a virtual operating platform that appears like networking hardware to the VMs 1008.

The VMs 1008 comprise virtual processing, virtual memory, virtual networking, or interface and virtual storage, and may be run by a corresponding virtualization layer 1006. Different embodiments of the instance of a virtual appliance 1002 may be implemented on one or more of the VMs 1008, and the implementations may be made in different ways. Virtualization of the hardware is in some contexts referred to as Network Function Virtualization (NFV). NFV may be used to consolidate many network equipment types onto industry standard high volume server hardware, physical switches, and physical storage, which can be located in data centers and customer premise equipment.

In the context of NFV, a VM 1008 may be a software implementation of a physical machine that runs programs as if they were executing on a physical, non-virtualized machine. Each of the VMs 1008, and that part of the hardware 1004 that executes that VM, be it hardware dedicated to that VM and/or hardware shared by that VM with others of the VMs 1008, forms separate virtual network elements. Still in the context of NFV, a virtual network function is responsible for handling specific network functions that run in one or more VMs 1008 on top of the hardware 1004 and corresponds to the application 1002.

The hardware 1004 may be implemented in a standalone network node with generic or specific components. The hardware 1004 may implement some functions via virtualization. Alternatively, the hardware 1004 may be part of a larger cluster of hardware (e.g., such as in a data center or CPE) where many hardware nodes work together and are managed via management and orchestration 1010, which, among others, oversees lifecycle management of the applications 1002. In some embodiments, the hardware 1004 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a RAN or a BS. In some embodiments, some signaling can be provided with the use of a control system 1012 which may alternatively be used for communication between hardware nodes and radio units.

FIG. 11 shows a communication diagram of a host 1102 communicating via a network node 1104 with a UE 1106 over a partially wireless connection in accordance with some embodiments. Example implementations, in accordance with various embodiments, of the UE (such as the UE 612A of FIG. 6 and/or the UE 700 of FIG. 7), the network node (such as the network node 610A of FIG. 6 and/or the network node 800 of FIG. 8), and the host (such as the host 616 of FIG. 6 and/or the host 900 of FIG. 9) discussed in the preceding paragraphs will now be described with reference to FIG. 11.

Like the host 900, embodiments of the host 1102 include hardware, such as a communication interface, processing circuitry, and memory. The host 1102 also includes software, which is stored in or is accessible by the host 1102 and executable by the processing circuitry. The software includes a host application that may be operable to provide a service to a remote user, such as the UE 1106 connecting via an OTT connection 1150 extending between the UE 1106 and the host 1102. In providing the service to the remote user, a host application may provide user data which is transmitted using the OTT connection 1150.

The network node 1104 includes hardware enabling it to communicate with the host 1102 and the UE 1106 via a connection 1160. The connection 1160 may be direct or pass through a core network (like the core network 606 of FIG. 6) and/or one or more other intermediate networks, such as one or more public, private, or hosted networks. For example, an intermediate network may be a backbone network or the Internet.

The UE 1106 includes hardware and software, which is stored in or accessible by the UE 1106 and executable by the UE's processing circuitry. The software includes a client application, such as a web browser or operator-specific “app” that may be operable to provide a service to a human or non-human user via the UE 1106 with the support of the host 1102. In the host 1102, an executing host application may communicate with the executing client application via the OTT connection 1150 terminating at the UE 1106 and the host 1102. In providing the service to the user, the UE's client application may receive request data from the host's host application and provide user data in response to the request data. The OTT connection 1150 may transfer both the request data and the user data. The UE's client application may interact with the user to generate the user data that it provides to the host application through the OTT connection 1150.

The OTT connection 1150 may extend via the connection 1160 between the host 1102 and the network node 1104 and via a wireless connection 1170 between the network node 1104 and the UE 1106 to provide the connection between the host 1102 and the UE 1106. The connection 1160 and the wireless connection 1170, over which the OTT connection 1150 may be provided, have been drawn abstractly to illustrate the communication between the host 1102 and the UE 1106 via the network node 1104, without explicit reference to any intermediary devices and the precise routing of messages via these devices.

As an example of transmitting data via the OTT connection 1150, in step 1108, the host 1102 provides user data, which may be performed by executing a host application. In some embodiments, the user data is associated with a particular human user interacting with the UE 1106. In other embodiments, the user data is associated with a UE 1106 that shares data with the host 1102 without explicit human interaction. In step 1110, the host 1102 initiates a transmission carrying the user data towards the UE 1106. The host 1102 may initiate the transmission responsive to a request transmitted by the UE 1106. The request may be caused by human interaction with the UE 1106 or by operation of the client application executing on the UE 1106. The transmission may pass via the network node 1104 in accordance with the teachings of the embodiments described throughout this disclosure. Accordingly, in step 1112, the network node 1104 transmits to the UE 1106 the user data that was carried in the transmission that the host 1102 initiated, in accordance with the teachings of the embodiments described throughout this disclosure. In step 1114, the UE 1106 receives the user data carried in the transmission, which may be performed by a client application executed on the UE 1106 associated with the host application executed by the host 1102.

In some examples, the UE 1106 executes a client application which provides user data to the host 1102. The user data may be provided in reaction or response to the data received from the host 1102. Accordingly, in step 1116, the UE 1106 may provide user data, which may be performed by executing the client application. In providing the user data, the client application may further consider user input received from the user via an input/output interface of the UE 1106. Regardless of the specific manner in which the user data was provided, the UE 1106 initiates, in step 1118, transmission of the user data towards the host 1102 via the network node 1104. In step 1120, in accordance with the teachings of the embodiments described throughout this disclosure, the network node 1104 receives user data from the UE 1106 and initiates transmission of the received user data towards the host 1102. In step 1122, the host 1102 receives the user data carried in the transmission initiated by the UE 1106.

One or more of the various embodiments improve the performance of OTT services provided to the UE 1106 using the OTT connection 1150, in which the wireless connection 1170 forms the last segment. More precisely, the teachings of these embodiments may improve, e.g., latency and thereby provide benefits such as, e.g., better responsiveness.

In an example scenario, factory status information may be collected and analyzed by the host 1102. As another example, the host 1102 may process audio and video data which may have been retrieved from a UE for use in creating maps. As another example, the host 1102 may collect and analyze real-time data to assist in controlling vehicle congestion (e.g., controlling traffic lights). As another example, the host 1102 may store surveillance video uploaded by a UE. As another example, the host 1102 may store or control access to media content such as video, audio, VR, or AR which it can broadcast, multicast, or unicast to UEs. As other examples, the host 1102 may be used for energy pricing, remote control of non-time critical electrical load to balance power generation needs, location services, presentation services (such as compiling diagrams etc. from data collected from remote devices), or any other function of collecting, retrieving, storing, analyzing, and/or transmitting data.

In some examples, a measurement procedure may be provided for the purpose of monitoring data rate, latency, and other factors on which the one or more embodiments improve. There may further be an optional network functionality for reconfiguring the OTT connection 1150 between the host 1102 and the UE 1106 in response to variations in the measurement results. The measurement procedure and/or the network functionality for reconfiguring the OTT connection 1150 may be implemented in software and hardware of the host 1102 and/or the UE 1106. In some embodiments, sensors (not shown) may be deployed in or in association with other devices through which the OTT connection 1150 passes; the sensors may participate in the measurement procedure by supplying values of the monitored quantities exemplified above, or by supplying values of other physical quantities from which software may compute or estimate the monitored quantities. The reconfiguring of the OTT connection 1150 may include message format, retransmission settings, preferred routing, etc.; the reconfiguring need not directly alter the operation of the network node 1104. Such procedures and functionalities may be known and practiced in the art. In certain embodiments, measurements may involve proprietary UE signaling that facilitates measurements of throughput, propagation times, latency, and the like by the host 1102. The measurements may be implemented in that software causes messages to be transmitted, in particular empty or ‘dummy’ messages, using the OTT connection 1150 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole and/or by end users and a wireless network generally.

Some example embodiments of the present disclosure are as follows:

### GROUP A EMBODIMENTS

Embodiment 1: A method performed by a User Equipment, UE, comprising: receiving (302), from a network node, a measurement configuration that comprises one or more priority indications for two or more frequencies; performing (304) measurements on the two or more frequencies in accordance with the one or more priority indications for the two or more frequencies; and transmitting (306), to the network node, a measurement report(s) comprising the measurements performed on the two or more frequencies.
Embodiment 2: The method of embodiment 1 wherein performing (304) the measurements on the two or more frequencies in accordance with the one or more priority indications for the two or more frequencies comprises performing (304) the measurements on the two or more frequencies in a chronological order that is defined by the one or more priority indications for the two or more frequencies.
Embodiment 3: The method of embodiment 1 or 2 wherein the UE is in connected mode.
Embodiment 4: The method of any of embodiments 1 to 3 further comprising transmitting (300), to the network node, a capability indication that indicates an ability of the UE to perform measurements in a configurable chronological order that is defined based on priorities of associated frequencies.
Embodiment 5: The method of any of the previous embodiments, further comprising: providing user data; and forwarding the user data to a host via a transmission to the network node.

### GROUP B EMBODIMENTS

Embodiment 6: A method performed by a network node, comprising: transmitting (402), to a UE, a measurement configuration that comprises one or more priority indications for two or more frequencies; and receiving (404), from the UE, a measurement report(s) comprising measurements performed on the two or more frequencies in accordance with the measurement configuration.
Embodiment 7: The method of embodiment 6 further comprising performing one or more actions based on the received measurement report(s).
Embodiment 8: The method of embodiment 6 wherein performing the one or more actions comprises transmitting a handover command to the UE, initiating a secondary cell setup procedure for the UE, or initiating a dual connectivity setup procedure for the UE.
Embodiment 9: The method of any of embodiments 6 to 8 wherein the UE is in connected mode.
Embodiment 10: The method of any of embodiments 6 to 9 further comprising receiving (400), from the UE, a capability indication that indicates an ability of the UE to perform measurements in a configurable chronological order that is defined based on priorities of associated frequencies.
Embodiment 11: A method performed by a network node, comprising: obtaining (500) capability information for a plurality of User Equipments, UEs, wherein the capability information indicates, for each UE, whether the UE has an ability to perform measurements on different frequencies in a configurable chronological order that is defined based on priorities assigned to the different frequencies; transmitting (502) measurement configurations to at least some of the plurality of UEs, the measurement configurations either including one or more priority indications for two or more frequencies or not, based on the capability information for the respective UEs.
Embodiment 12: The method of embodiment 11 wherein obtaining (500) the capability information for the plurality of UEs comprises: obtaining (500A) capability information for UEs in a first set of UEs that indicates that the UEs in the first set of UEs each has an ability to perform measurements on different frequencies in a configurable chronological order that is defined based on priorities assigned to the different frequencies; and obtaining (500A) capability information for UEs in a second set of UEs that indicates that the UEs in the second set of UEs each does not have an ability to perform measurements on different frequencies in a configurable chronological order that is defined based on priorities assigned to the different frequencies.
Embodiment 13: The method of embodiment 12 wherein transmitting (502) the measurement configurations comprises: transmitting (502A) a first measurement configuration to a first UE in the first set of UEs, the first measurement configuration comprising one or more priority indications for two or more frequencies; and transmitting (502B) a second measurement configuration to a second UE in the second set of UEs, the second measurement configuration not comprising one or more priority indications for different frequencies.
Embodiment 14: The method of embodiment 13 further comprising: receiving (504A) a first measurement report from the first UE in the first set of UEs; and receiving (504B) a second measurement report from the second UE in the second set of UEs.
Embodiment 15: The method of embodiment 14 further comprising performing (506) one or more actions based on the first measurement report and the second measurement report.
Embodiment 16: The method of embodiment 15 wherein performing (506) one or more actions based on the first measurement report and the second measurement report comprises performing a first set of actions based on the first measurement report as a result of the first UE being in the first set of UEs and performing a second set of actions, which is different than the first set of actions, based on the second measurement report as a result of the second UE being in the second set of UEs.
Embodiment 17: The method of embodiment 15 or 16 wherein performing (506) one or more actions based on the first measurement report and the second measurement report comprises: determining (506A) that the first measurement report is from the first UE in the first set of UEs; and, responsive to determining (506A) that the first measurement report is from the first UE in the first set of UEs, transmitting (506B) a handover command to the first UE, initiating a secondary cell setup procedure for the first UE, or initiating a dual connectivity setup procedure for the first UE.
Embodiment 18: The method of any of embodiments 15 to 17 wherein performing (506) one or more actions based on the first measurement report and the second measurement report comprises: determining (506C) that the second measurement report is from the second UE in the second set of UEs; determining (506D) that measurement(s) in the second measurement report are for a frequency(s) or cell(s) having a lower priority (e.g., a priority that is less than a threshold priority); and, responsive to determining (506D) that measurement(s) in the second measurement report are for a frequency(s) or cell(s) having a lower priority, waiting (506E) (e.g., for a limited amount of time) for a third measurement report from the second UE.
Embodiment 19: The method of embodiment 18 further comprising: receiving (506F) a third measurement report from the second UE; and performing (506G) an action(s) based on the third measurement report.
Embodiment 20: The method of any of embodiments 15 to 17 wherein performing (506) one or more actions based on the first measurement report and the second measurement report comprises: determining (506C) that the second measurement report is from the second UE in the second set of UEs; determining (506H) that measurement(s) in the second measurement report are for a frequency(s) or cell(s) having a higher priority (e.g., a priority that is greater than a threshold priority); and, responsive to determining (506H) that measurement(s) in the second measurement report are for a frequency(s) or cell(s) having a higher priority, transmitting (506I) a handover command to the second UE, initiating a secondary cell setup procedure for the second UE, or initiating a dual connectivity setup procedure for the second UE.

### GROUP C EMBODIMENTS

Embodiment 21: A user equipment comprising: processing circuitry configured to perform any of the steps of any of the Group A embodiments; and power supply circuitry configured to supply power to the processing circuitry.
Embodiment 22: A network node comprising: processing circuitry configured to perform any of the steps of any of the Group B embodiments; power supply circuitry configured to supply power to the processing circuitry.
Embodiment 23: A user equipment (UE) comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.
Embodiment 24: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to receive the user data from the host.
Embodiment 25: The host of the previous embodiment, wherein the cellular network further includes a network node configured to communicate with the UE to transmit the user data to the UE from the host.
Embodiment 26: The host of the previous 2 embodiments, wherein: the processing circuitry of the host is configured to execute a host application, thereby providing the user data; and the host application is configured to interact with a client application executing on the UE, the client application being associated with the host application.
Embodiment 27: A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.
Embodiment 28: The method of the previous embodiment, further comprising: at the host, executing a host application associated with a client application executing on the UE to receive the user data from the UE.
Embodiment 29: The method of the previous embodiment, further comprising: at the host, transmitting input data to the client application executing on the UE, the input data being provided by executing the host application, wherein the user data is provided by the client application in response to the input data from the host application.
Embodiment 30: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to transmit the user data to the host.
Embodiment 31: The host of the previous embodiment, wherein the cellular network further includes a network node configured to communicate with the UE to transmit the user data from the UE to the host.
Embodiment 32: The host of the previous 2 embodiments, wherein: the processing circuitry of the host is configured to execute a host application, thereby providing the user data; and the host application is configured to interact with a client application executing on the UE, the client application being associated with the host application.
Embodiment 33: A method implemented by a host configured to operate in a communication system that further includes a network node and a user equipment (UE), the method comprising: at the host, receiving user data transmitted to the host via the network node by the UE, wherein the UE performs any of the steps of any of the Group A embodiments to transmit the user data to the host.
Embodiment 34: The method of the previous embodiment, further comprising: at the host, executing a host application associated with a client application executing on the UE to receive the user data from the UE.
Embodiment 35: The method of the previous embodiment, further comprising: at the host, transmitting input data to the client application executing on the UE, the input data being provided by executing the host application, wherein the user data is provided by the client application in response to the input data from the host application.
Embodiment 36: A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.
Embodiment 37: The host of the previous embodiment, wherein: the processing circuitry of the host is configured to execute a host application that provides the user data; and the UE comprises processing circuitry configured to execute a client application associated with the host application to receive the transmission of user data from the host.
Embodiment 38: A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B embodiments to transmit the user data from the host to the UE.
Embodiment 39: The method of the previous embodiment, further comprising, at the network node, transmitting the user data provided by the host for the UE.
Embodiment 40: The method of any of the previous 2 embodiments, wherein the user data is provided at the host by executing a host application that interacts with a client application executing on the UE, the client application being associated with the host application.
Embodiment 41: A communication system configured to provide an over-the-top service, the communication system comprising a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.
Embodiment 42: The communication system of the previous embodiment, further comprising: the network node; and/or the user equipment.
Embodiment 43: A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.
Embodiment 44: The host of the previous 2 embodiments, wherein: the processing circuitry of the host is configured to execute a host application, thereby providing the user data; and the host application is configured to interact with a client application executing on the UE, the client application being associated with the host application.
Embodiment 45: The host of the any of the previous 2 embodiments, wherein the initiating receipt of the user data comprises requesting the user data.
Embodiment 46: A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B embodiments to receive the user data from the UE for the host.
Embodiment 47: The method of the previous embodiment, further comprising at the network node, transmitting the received user data to the host.

Those skilled in the art will recognize improvements and modifications to the embodiments of the present disclosure. All such improvements and modifications are considered within the scope of the concepts disclosed herein.

1. A method performed by a User Equipment, UE, the method comprising:
receiving, from a network node, a measurement configuration that comprises one or more priority indications for two or more frequencies;
performing measurements on the two or more frequencies in accordance with the one or more priority indications for the two or more frequencies; and
transmitting, to the network node, one or more measurement reports comprising the measurements performed on the two or more frequencies.

2. The method of claim 1 wherein performing the measurements on the two or more frequencies in accordance with the one or more priority indications for the two or more frequencies comprises performing the measurements on the two or more frequencies in a chronological order that is defined by the one or more priority indications for the two or more frequencies.

3. The method of claim 1 wherein the UE is in connected mode.

4. The method of claim 1 further comprising transmitting, to the network node, a capability indication that indicates an ability of the UE to perform measurements in a configurable chronological order that is defined based on priorities of associated frequencies.

5. The method of claim 1 wherein the one or more priority indications comprise a separate priority indication for each of the two or more frequencies.

6. (canceled)

7. (canceled)

8. A User Equipment, UE, comprising:
a communication interface comprising a transmitter and a receiver; and
processing circuitry associated with the communication interface, the processing circuitry configured to cause the UE to:
receive, from a network node, a measurement configuration that comprises one or more priority indications for two or more frequencies;
perform measurements on the two or more frequencies in accordance with the one or more priority indications for the two or more frequencies; and
transmitting, to the network node, one or more measurement reports comprising the measurements performed on the two or more frequencies.

9. (canceled)

10. A method performed by a network node, comprising:
transmitting, to a User Equipment, UE, a measurement configuration that comprises one or more priority indications for two or more frequencies; and
receiving, from the UE, one or more measurement reports comprising measurements performed on the two or more frequencies in accordance with the measurement configuration.

11. The method of claim 10 further comprising performing one or more actions based on the received measurement report(s).

12. The method of claim 10 wherein performing the one or more actions comprises transmitting a handover command to the UE, initiating a secondary cell setup procedure for the UE, or initiating a dual connectivity setup procedure for the UE.

13. The method of claim 10 wherein the UE is in connected mode.

14. The method of claim 10 further comprising receiving, from the UE, a capability indication that indicates an ability of the UE to perform measurements in a configurable chronological order that is defined based on priorities of associated frequencies.

15. (canceled)

16. (canceled)

17. A network node comprising processing circuitry configured to cause the network node to:
transmit, to a User Equipment, UE, a measurement configuration that comprises one or more priority indications for two or more frequencies; and
receive, from the UE, one or more measurement reports comprising measurements performed on the two or more frequencies in accordance with the measurement configuration.

18-32. (canceled)
